(19) United States
(12) Patent Application Publication
(10) Pub. No.: US 2007/0264298 A1
(43) Pub. Date: Nov. 15, 2007

(54) Harvestwinner

(75) Inventor: Cheng Wen Shih, Bangkok (TH)

Correspondence Address: Stephen W. Lee, 105 Kettle Lane, Houma, LA, 70360, US

(73) Assignee: Stephen W. Lee, Houma, LA (US)

(21) Appl. No.: 11/800,536

(22) Filed: May 7, 2007

Related U.S. Application Data
(60) Provisional application No. 60/799,580, filed on May 10, 2006.

(51) Int. Cl. A01N 65/00; A01N 25/08

(52) U.S. Cl. 424/410; 424/725

(57) ABSTRACT

General Information:

This Composition of matter removes snails/slugs and all mollusk's in any environment, agriculture aquaculture, marine applications, commercial & private

Technical Information:

Saponin 25.03% Inert ingredients 74.97% Ingredients' are all natural and non toxic to humans and animals. Ingredients are derived during the process of removing oil from tea seeds, this oil is used in many cooking applications and soap making worldwide. The waste from this process is formed into cakes and dried out (Saponin). We use these cakes and our other ingredients' grind them to required Mesh counts to produce the effect desired of our product. Different mesh counts have an effect on time of activation of our product. Varying situations call for specialized mesh counts longer or shorter activation times. Our formulation has been tested and refined to exacting standards. This composition of mater known as Harvestwinner should not be infringed on

### INVENTION BACKGROUND

This formulation was conceived out of agriculture needs for the region that live and work in snails, slugs, and mussels cause considerable damage to rice crops, fish farming, and shrimp farming and needed to be addressed in order to assure a quality harvest. I have been involved in agriculture and aquaculture for over 30 years and developed this all natural formula to relieve these problems due to mollusks' in any environment world wide.

Is an all natural product for the control and removal of snails and slugs.

This formulation of ingredients removes mollusks' in any environment. Applications: for aquaculture, agriculture, field crops, greenhouses, commercial and private. Harvestwinner is derived from 100% Non toxic organic materials and leaves no residuals in the environment

Organic product for the control and removal of snail's, slug's, and all members of the mollusk family Formulated to eliminate adult, juvenile and eggs of any mollusks. This product is made from all natural ingredients' and raw materials. Harvestwinner activates on contact with mollusks or water, and continues to react for 8 hours. It is environmentally safe. Non toxic to Humans. 100% biodegradable.

*See attached Sample Description of product and usage.

1. Is an all natural product for the control and removal of snails and slugs.
This formulation of ingredients removes all mollusks in any environment.
Applications: for aquaculture, agriculture, and marine farming, field crops, dicondra & turf grass lawns, ornamental plants & greenhouses, seed crops, small fruits & berries, tree crops, vegetable crops and gardens
